(19) United States
(12) Patent Application Publication
(10) Pub. No.: US 2017/0188591 A1
(43) Pub. Date: Jul. 6, 2017

(54) Methods and Compositions for Preparing A Baked Product

(71) Applicant: Novozymes A/S, Bagsvaerd (DK)

(72) Inventors: Guillermo Bellido, Hegenheim (FR); Gianluca Gazzola, Castelnuovo Del Garda (IT)

(73) Assignee: Novozymes A/S, Bagsvaerd (DK)

(21) Appl. No.: 15/305,005

(22) PCT Filed: Apr. 20, 2015
(86) PCT No.: PCT/EP2015/058504

§ 371 Date: Oct. 18, 2016

(30) Foreign Application Priority Data
Apr. 22, 2014 (EP) 14165380.8

(51) Int. Cl. A21D 8/04; A21D 10/00

(52) U.S. Cl. CPC A21D 8/04; A21D 10/00

(57) ABSTRACT

The present invention provides a method for modifying the crumb of a baked product comprising adding an arabinofuranosidase and an anti-staling amylase to dough ingredients and baking the dough to provide the baked product, wherein the anti-staling amylase is a maltogenic alpha-amylase or a glucan 1,4-alpha-maltotetrahydrolase.

### REFERENCE TO A SEQUENCE LISTING

This application contains a Sequence Listing in computer readable form. The computer readable form is incorporated herein by reference.

### FIELD OF THE INVENTION

The present invention relates to a method for the production of a baked product with improved eating quality, improved shelf life, and improved crumb properties, by adding an arabinofuranosidase and an anti-staling amylase to the dough.

### BACKGROUND OF THE INVENTION

Anti-staling enzymes have been successfully used in the baking industry for over 20 years (WO 1991/04669). Addition of a recommended dosage of an anti-staling enzyme slows the rate at which bread crumb becomes firmer and less elastic. These benefits have made the use of anti-staling enzymes an almost ubiquitous ingredient in breads made by industrial bakeries today.

However, there is a need for methods for the production of baked products with an improved shelf life and at the same time an improved eating quality, especially improved crumb properties.

### SUMMARY OF THE INVENTION

Surprisingly, it has been found that it is possible to improve the eating properties, the crumb properties, and the shelf life of a baked product, so we claim:

A method for modifying the crumb of a baked product comprising adding an arabinofuranosidase and an anti-staling amylase to dough ingredients and baking the dough to provide the baked product, wherein the anti-staling amylase is a maltogenic alpha-amylase or a glucan 1,4-alpha-maltotetrahydrolase.

In one embodiment, the baked product is a bread or a cake.

In one embodiment, the arabinofuranosidase belongs to family 43, family 51, family 54, or family 62.

In one embodiment, the arabinofuranosidase has an amino acid sequence having at least 70% identity to SEQ ID NO:1 or SEQ ID NO:2.

In one embodiment, the bread crumb of the bread product has improved bread crumb melting properties compared to a baked product prepared without arabinofuranosidase.

In one embodiment, the bread crumb of the bread product has improved bread crumb smoothness properties compared to a baked product prepared without arabinofuranosidase.

In one embodiment, additionally a phospholipase is added to the dough ingredients.

In one embodiment, additionally one or more enzymes selected from the group consisting of a xylanase, an amylase, a galactolipase, a protease, a transglutaminase, a cellulase, a hemicellulase, an acyltransferase, a protein disulfide isomerase, a pectinase, a pectate lyase, an oxidoreductase, a peroxidase, a laccase, a glucose oxidase, a pyranose oxidase, a hexose oxidase, a lipoxygenase, an L-amino acid oxidase or a carbohydrate oxidase, a sulfurhydryl oxidase, and a glucoamylase is added to the dough ingredients.

The present invention also discloses a baked product obtainable by the method of the invention.

The present invention also discloses the use of an arabinofuranosidase and an anti-staling amylase for modifying the crumb of a baked product, wherein the anti-staling amylase is a maltogenic alpha-amylase or a glucan 1,4-alpha-maltotetrahydrolase.

The present invention also discloses the use of an arabinofuranosidase and an anti-staling amylase for improving the bread crumb melting properties and/or improved bread crumb smoothness properties compared to a baked product prepared without arabinofuranosidase.

The present invention also discloses a method, wherein the baked product has improved eating properties, improved shelf life, and improved crumb.

### DETAILED DESCRIPTION OF THE INVENTION

### Definitions

Baked product: As used herein, “baked product” means any kind of baked product with a crumb including breads and cakes. All kinds of breads are included, in particular bread types such as pan bread, toast bread, open bread, pan bread with and without lid, buns, hamburger buns, rolls, baguettes, brown bread, whole meal bread, rich bread, bran bread, sweet breads such as brioche and pain-au-lait, and any variety thereof. All kinds of cakes are included, in particular cakes such as batter cake, sponge cake, and any variety thereof.

Dough: As used herein “dough” means any dough or batter used to prepare a baked product. The dough used to prepare a baked product may be made from any suitable dough ingredients, including flour sourced from grains, such as, wheat flour, corn flour, rye flour, barley flour, oat flour, rice flour, or sorghum flour, potato flour, soy flour, and combinations thereof (e.g., wheat flour combined with one of the other flour sources; rice flour combined with one of the other flour sources). The dough according to the invention may be a leavened dough, or a dough to be subjected to leavening. The dough may be leavened in various ways, such as by adding dough ingredients such as chemical leavening agents, e.g., sodium bicarbonate or by adding a leaven (fermenting dough). In one embodiment of the invention, the dough is leavened by adding a suitable yeast culture, such as a culture of Saccharomyces cerevisiae (baker's yeast), e.g., a commercially available strain of S. cerevisiae.

The dough may also comprise other conventional dough ingredients, e.g., proteins such as milk powder, gluten, and/or soy; eggs (either whole eggs, egg yolks or egg whites); an oxidant such as ascorbic acid, potassium bromate, potassium iodate, azodicarbonamide (ADA) and/or ammonium persulfate; an amino acid such as L-cysteine; a sugar; a salt such as sodium chloride, calcium acetate, sodium sulphate, and/or calcium sulphate; diluents such silica dioxide; and starch of different origins. Still other convention ingredients include hydrocolloids such as CMC, guar gum, xanthan gum, locust bean gum, etc. Modified starches may be also used.

The dough ingredients may comprise fat (triglyceride) such as granulated fat or shortening.

In a preferred embodiment, the dough ingredients comprise wheat flour; preferably 10% (w/w) or more of the total flour content is wheat flour, preferably at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, or preferably at least 95% (w/w) of the flour is wheat flour.

The dough may be prepared by applying any conventional mixing process, such as the continuous mix process, the straight-dough process, or the sponge and dough method.

Sequence identity: As used herein, the degree of sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labelled “longest identity” (obtained using the -no brief option) is used as the percent identity and is calculated as follows:

(Identical Residues×100)/(Length of Alignment−Total Number of Gaps in Alignment).

Bread crumb melting properties: As used herein, the bread crumb melting properties mean how easily the crumb melts in the mouth during mastication scored by a trained evaluator and compared to a reference.

Bread crumb smoothness properties: As used herein, the bread crumb smoothness properties mean degree of abrasiveness or how smooth sample are when rubbed between the tongue and palate during mastication and swallowing scored by a trained evaluator and compared to a reference.

### Industrial Processes

The present invention is particularly useful for preparing dough and baked products in industrialized processes in which the dough used to prepare the baked products are prepared mechanically using automated or semi-automated equipment.

### Breads

Bread refers to a food prepared by baking a dough typically comprising flour, water, yeast, and salt. The process of preparing a bread generally involves the sequential steps of dough making (with an optional proofing step), sheeting or dividing, shaping or rolling, and proofing the dough, which steps are well known in the art. If the optional proofing step is used, preferably more flour is added and alkali may be added to neutralize acid produced or to be produced during the second proofing step.

### Cakes

The term “pound cake” refers to traditional cakes which are made with an equal amount of each of the following four ingredients: flour, fat, eggs, and sugar. In the present invention pound cakes include cakes wherein the formula may differ from the traditional pound cakes so long as the amount of fat, eggs and sugar relative to the amount of flour is within the range of 25%-175% (flour weight basis). A cake with such relative amounts of flour, fat, eggs and sugar is also known as a batter cake according to American Institute of Baking.

There are numerous variations on pound cakes beyond the relative amount of the four basis ingredients, with certain countries and regions having distinctive styles. These variations include the addition of flavouring agents, dried fruit, as well as alterations to the original recipe to change the characteristics of the resulting pound cake. These alterations include using baking powder and/or a food chemical emulsifier to change the degree of aeration of the batter, resulting in a less or more dense pound cake. In the present invention typical batter density of the pound cake batter span the range of 0.5 to 1 g/ml. Other formula variations also include various types of fat as this can be butter, baking fat, oil, sour cream, or a combination of these four. Pound cake are typically baked in a loaf pan or a Bundt mold, but the same batter used for making a pound cake can also be baked into smaller formats and be referred to as a muffin or a cupcake. Some examples of pound cake include the golden pound cake, 100% whole wheat pound cake, chocolate pound cake, marble pound cake, and raisin pound cake.

The term sponge cake encompasses cakes that are in principle made from flour, sugar, eggs, a leavening agent, and in the case of industrial cakes also a food chemical emulsifier. Sponge cakes are the basis for making many cake types and hence represent a large and important segment of the world cake market. They are compositionally and structurally different from the other major group of cakes, batter cakes (e.g., pound cakes), in that they do not contain oil (or typically do not) and have a springy (elastic), highly aerated structure—batter cakes contain a significant amount of oil, and they have a much firmer and denser (much less aerated) structure.

### Enzymes

The present invention is directed to methods and compositions for preparing a dough used to prepare a baked product. The present invention is also directed to methods for preparing a baked product by applying specific enzymes to a dough. The enzyme combination comprises at least an arabinofuranosidase and an anti-staling amylase, wherein the anti-staling amylase is a maltogenic alpha-amylase or a glucan 1,4-alpha-maltotetrahydrolase.

### Arabinofuranosidases

The arabinofuranosidase according to the invention may be an alpha-L-arabinofuranosidase. In particular, the arabinofuranosidase may be an alpha-L-arabinofuranosidase family 43 (GH43), an alpha-L-arabinofuranosidase family 51 (GH51), an alpha-L-arabinofuranosidase family 54 (GH54), or an alpha-L-arabinofuranosidase family 62 (GH62).

In one embodiment, the arabinofuranosidase may be added to flour or dough in an amount of 0.1-10,000 ppm, for example 0.1-10 ppm, 1-10 ppm, 1-50 ppm, 1-100 ppm, 1-200 ppm, 1-300 ppm, 1-400 ppm, 1-500 ppm, 5-500 ppm, 10-500 ppm, 15-500 ppm, 20-500 ppm (mg enzyme protein per kg flour).

### Arabinofuranosidase Family 43 (GH43)

An arabinofuranosidase family 43, or also called alpha-L-arabinofuranosidase of GH43, has activity towards di-substituted xyloses. It may be of microbial origin, e.g., derivable from a strain of a filamentous fungus (e.g., Humicola, Aspergillus, Trichoderma, Fusarium, Penicillum) or from a bacteria (e.g., Bacillus, Bifidobacterium).

Preferably, the arabinofuranosidase GH43 is derived from Humicola insolens. Most preferably the arabinofuranosidase GH43 has at least 70% identity to the sequence shown in SEQ ID NO:1; preferably the arabinofuranosidase GH43 has at least 75% identity to the sequence shown in SEQ ID NO:1; preferably the arabinofuranosidase GH43 has at least 80% identity to the sequence shown in SEQ ID NO:1; preferably the arabinofuranosidase GH43 has at least 85% identity to the sequence shown in SEQ ID NO:1; preferably the arabinofuranosidase GH43 has at least 90% identity to the sequence shown in SEQ ID NO:1; preferably the arabinofuranosidase GH43 has at least 91% identity to the sequence shown in SEQ ID NO:1; preferably the arabinofuranosidase GH43 has at least 92% identity to the sequence shown in SEQ ID NO:1; preferably the arabinofuranosidase GH43 has at least 93% identity to the sequence shown in SEQ ID NO:1; preferably the arabinofuranosidase GH43 has at least 94% identity to the sequence shown in SEQ ID NO:1; preferably the arabinofuranosidase GH43 has at least 95% identity to the sequence shown in SEQ ID NO:1; preferably the arabinofuranosidase GH43 has at least 96% identity to the sequence shown in SEQ ID NO:1; preferably the arabinofuranosidase GH43 has at least 97% identity to the sequence shown in SEQ ID NO:1; preferably the arabinofuranosidase GH43 has at least 98% identity to the sequence shown in SEQ ID NO:1; preferably the arabinofuranosidase GH43 has at least 99% identity to the sequence shown in SEQ ID NO:1; preferably the arabinofuranosidase GH43 has 100% identity to the sequence shown in SEQ ID NO:1.

The arabinofuranosidase GH43 may also be derived from Bifidobacterium adolescenti. More preferably, the arabinofuranosidase GH43 is the enzyme described by Van Laere, 1997, in Appl. Microbiol. Biotechnol, 47, 231-235 and/or by Van den Broek, 2005, in Applied Microbiology and Biotechnology.

### Arabinofuranosidase Family 51 (GH51)

An arabinofuranosidase family 51, or also called alpha-L-arabinofuranosidase of GH51, has activity towards di-substituted xyloses. It may be of microbial origin, e.g., derivable from a strain of a filamentous fungus (e.g., Meripilus, Humicola, Aspergillus, Trichoderma, Fusarium, Penicillum) or from a bacteria (e.g. Bacillus).

Preferably, the enzyme is an arabinofuranosidase of GH51 derived from Meripilus giganteus. Most preferably, the arabinofuranosidase GH51 has at least 70% identity to the sequence shown in SEQ ID NO:2; preferably the arabinofuranosidase GH51 has at least 75% identity to the sequence shown in SEQ ID NO:2; preferably the arabinofuranosidase GH51 has at least 80% identity to the sequence shown in SEQ ID NO:2; preferably the arabinofuranosidase GH51 has at least 85% identity to the sequence shown in SEQ ID NO:2; preferably the arabinofuranosidase GH51 has at least 90% identity to the sequence shown in SEQ ID NO:2; preferably the arabinofuranosidase GH51 has at least 91% identity to the sequence shown in SEQ ID NO:2; preferably the arabinofuranosidase GH51 has at least 92% identity to the sequence shown in SEQ ID NO:2; preferably the arabinofuranosidase GH51 has at least 93% identity to the sequence shown in SEQ ID NO:2; preferably the arabinofuranosidase GH51 has at least 94% identity to the sequence shown in SEQ ID NO:2; preferably the arabinofuranosidase GH51 has at least 95% identity to the sequence shown in SEQ ID NO:2; preferably the arabinofuranosidase GH51 has at least 96% identity to the sequence shown in SEQ ID NO:2; preferably the arabinofuranosidase GH51 has at least 97% identity to the sequence shown in SEQ ID NO:2; preferably the arabinofuranosidase GH51 has at least 98% identity to the sequence shown in SEQ ID NO:2; preferably the arabinofuranosidase GH51 has at least 99% identity to the sequence shown in SEQ ID NO:2; preferably the arabinofuranosidase GH51 has 100% identity to the sequence shown in SEQ ID NO:2.

### Anti-Staling Amylase

An anti-staling amylase for use in the present invention is a maltogenic alpha-amylase or a glucan 1,4-alpha-maltotetrahydrolase.

The anti-staling amylase is effective in retarding the staling (crumb firming) of baked products. The anti-staling amylase preferably has a temperature optimum in the presence of starch in the range of 30-90° C. The temperature optimum may be measured in a 1% solution of soluble starch at pH 5.5.

The anti-staling amylase is preferably a maltogenic alpha-amylase (EC 3.2.1.133), e.g., from Bacillus.

A maltogenic alpha-amylase from B. stearothermophilus strain NCIB 11837 is commercially available from Novozymes NS under the trade name NOVAMYL.

The maltogenic alpha-amylase may also be a variant of the maltogenic alpha-amylase from B. stearothermophilus, e.g., a variant disclosed in WO 1999/043794; WO 2006/032281; or WO 2008/148845, e.g., Novamyl Pro™.

An anti-staling amylase for use in the invention may also be an amylase known as a glucan 1,4-alpha-maltotetrahydrolase (EC 3.2.1.60), e.g., an amylase from Pseudomonas saccharophilia or variants thereof, such as any of the amylases disclosed in WO 1999/050399, WO2004/111217 or WO2005/003339.

The anti-staling amylase may typically be added in the range of 0.01-200 mg of enzyme protein per kg of flour, e.g., 1-100 mg of enzyme protein per kg of flour (1-100 ppm).

A maltogenic alpha-amylase may preferably be added in an amount of 50-5000 MANU/kg of flour, e.g., 100-1000 MANU/kg.

### Phospholipases

The phospholipase may be a phospholipase A1 (EC 3.1.1.32), or the phospholipase may be a phospholipase A2 (EC 3.1.1.4). Most preferably, the phospholipase has phospholipase A1 activity, e.g., such as the Fusarium oxysporum phospholipase disclosed in WO 1998/26057.

Suitable commercial phospholipase preparations are LIPOPAN F™ and LIPOPAN Xtra™. Both products are available from Novozymes A/S. Also suitable is the phospholipase composition PANAMORE™ available from DSM.

It is preferred that the dough comprises up to 5000 ppm of the phospholipase; e.g., up to 4000 ppm, 3000 ppm, 2000 ppm, e.g., 1-2000 ppm (mg enzyme protein per kg flour).

### Other Enzymes

One or more additional enzymes may be added to the dough. The additional enzymes may be selected from the group consisting of a xylanase, an amylase, a galactolipase, a protease, a transglutaminase, a cellulase, a hemicellulase, an acyltransferase, a protein disulfide isomerase, a pectinase, a pectate lyase, an oxidoreductase, a peroxidase, a laccase, a glucose oxidase, a pyranose oxidase, a hexose oxidase, a lipoxygenase, an L-amino acid oxidase, a carbohydrate oxidase, a sulfurhydryl oxidase, and a glucoamylase.

The one or more additional enzymes may be of any origin, including mammalian, plant, and preferably microbial (bacterial, yeast or fungal) origin and may be obtained by techniques conventionally used in the art.

The arabinofuranosidase and the anti-staling amylase as well as optionally one or more additional enzymes may be added to flour or dough in any suitable form, such as, e.g., in the form of a liquid, in particular a stabilized liquid, or it may be added to flour or dough as a substantially dry powder or granulate. Granulates may be produced, e.g., as disclosed in U.S. Pat. No. 4,106,991 and U.S. Pat. No. 4,661,452. Liquid enzyme preparations may, for instance, be stabilized by adding a sugar or sugar alcohol or lactic acid according to established procedures. Other enzyme stabilizers are well-known in the art. The enzyme combination treatment may be added to the dough ingredients in any suitable manner, such as individual components (separate or sequential addition of the enzymes) or addition of the enzymes together in one step or one composition.

### Baking Composition

The present invention further relates to a baking composition comprising an arabinofuranosidase and an anti-staling amylase.

The present invention further relates to a baking composition comprising an arabinofuranosidase, an anti-staling amylase and a phospholipase.

The baking composition may contain other dough-improving and/or bread-improving additives, e.g., any of the additives, including enzymes, mentioned above. The baking composition may be, e.g., a dough, a flour composition, or a flour pre-mix, or a bread improver, or a cake improver.

### Pre-Mixes

It will often be advantageous to provide the enzymes used in the treatment of the present invention in admixture with other ingredients used to improve the properties of baked products. These baking compositions are commonly known in the art as “pre-mixes,” which usually comprise flour. Hence, in a further aspect, the present invention relates to a bread premix or a cake premix for improving the quality of dough used to prepare a baked product, which premix comprises the enzyme combination of the present invention, e.g., an arabinofuranosidase and an anti-staling amylase in combination with one or more dough ingredients, e.g., the ingredients described above. The pre-mix composition may be in liquid form or dry or substantially dry form.

In one embodiment, the present invention further relates to a bread pre-mix comprising the enzyme combination of the present invention and flour, such as, flour from grains, such as, wheat flour, corn flour, rye flour, barley flour, oat flour, rice flour, or sorghum flour, and combinations thereof. In another embodiment, the present invention relates to a bread pre-mix comprising the enzyme combination of the present invention and flour, such as, flour from grains, such as, wheat flour, corn flour, rye flour, barley flour, oat flour, rice flour, sorghum, soy flour, and combinations thereof, and one or more additional enzymes, as previously described.

The pre-mix may be in the form of a granulate or an agglomerated powder, e.g., wherein at least 95% (by weight) of the granulate or agglomerated powder has a particle size between 25 and 500 μm.

Granulates and agglomerated powders may be prepared by conventional methods, e.g., by spraying the enzymes onto a carrier in a fluid-bed granulator. The carrier may consist of particulate cores having a suitable particle size. The carrier may be soluble or insoluble, e.g., a salt (such as NaCl or sodium sulfate), a sugar (such as sucrose or lactose), a sugar alcohol (such as sorbitol), starch, rice, corn grits, and/or soy.

Properties of the Baked Product

In one embodiment, the baked product prepared by the methods and compositions of the invention provides improved eating properties.

Gumminess and chewiness may be measured using a texture profile analyzer. Gumminess may be measured as hardness multiplied by cohesiveness of the product. Gumminess is a characteristic of semisolid food with a low degree of hardness and a high degree of cohesiveness.

Chewiness is defined as the product of gumminess times springiness (which also equals hardness times cohesiveness times springiness) and is therefore influenced by the change in any one of these parameters.

Hardness, cohesiveness, resiliency, springiness, gumminess (or stickiness), and chewiness, crumb structure may typically be compared to a control (i.e., a baked product prepared under identical conditions but without the enzyme treatments of the present invention). These concepts and measurements are also described in Bourne, M. C., Food Texture and Viscosity. Concept and Measurement, Second Edition (2002).

Other tests known in the art may be used to assess the organoleptic qualities of the baked product prepared by the methods and compositions of the present invention.

The properties of the baked product may be referred to herein as organoleptic properties, which include anti-staling (bread crumb firmness/hardness), crumb properties and mouth feel, or more precisely, the attributes of the baked product as detected in the mouth during eating (e.g., bread or cake softness/resistance to first bite, crumb moistness, crumb chewiness and gumminess, and crumb smoothness and melting properties).

### Storage/Shelf Life

In one embodiment, the present invention relates to a baked product having an improved shelf life.

Shelf life may be measured as follows: A baked product is prepared using the enzyme composition of the present invention (i.e., an arabinofuranosidase and an anti-staling amylase) and compared to a control baked product, wherein the baked product is prepared in the same way but without the enzyme composition of the present invention.

The baked product is stored in a sealed plastic bag at a temperature of typically 20-25° C. After the storage period, (e.g., 1 hour, 24 hours, 48 hours, 72 hours, 96 hours, 7 days, 14 days, 21 days etc.), the hardness of the baked product may be measured using a texture analyzer and compared to a control baked product stored under identical conditions. An improved shelf life is defined as a baked product which is less hard (i.e., softer) than the control as measured by the texture analyzer.

In addition to preparing fresh dough or baked products, the present invention is directed to a method for preparing a dough that can be stored, e.g., at room temperature or with refrigeration, or frozen prior to baking. The dough can be stored and/or be frozen after preparation of the dough and treatment by the enzyme combination of the present invention (i.e., prior to baking).

In one embodiment, the baked product is also compared to a control and other enzymes treatments in various quality parameters. The baked product prepared by the enzyme treatment of the present invention may be analyzed at a time after baking or during storage (e.g., 1 hour after baking and/or 24 hours, 48 hours, 72 hours, 96 hours, 7 days, 14 days, 21 days, etc. post baking).

The invention described and claimed herein is not to be limited in scope by the specific embodiments herein disclosed, since these embodiments are intended as illustrations of several aspects of the invention. Any equivalent embodiments are intended to be within the scope of this invention as well as combinations of one or more of the embodiments. Various modifications of the invention in addition to those shown and described herein will become apparent to those skilled in the art from the foregoing description. Such modifications are also intended to fall within the scope of the appended claims.

The present invention is further described by the following examples which should not be construed as limiting the scope of the invention. For example, routine modifications to optimize the methods of enzymatic modification according to the present invention are contemplated.

### Materials and Methods

### Maltogenic Alpha-Amylase Assay

The activity of a maltogenic alpha-amylase may be determined using an activity assay such as the MANU method. One MANU (Maltogenic Amylase Novo Unit) is defined as the amount of enzyme required to release one micro-mole of maltose per minute at a concentration of 10 mg of maltotriose substrate per ml in 0.1 M citrate buffer at pH 5.0, 37° C. for 30 minutes.

Assay for Activity Towards alpha-L-arabinofuranosidase Activity

Alpha-L-arabinofuranosidase activity may be assessed as described by Poutanen et al. (Appl. Microbiol. Biotechnol. 1988, 28, 425-432) using 5 mM p-nitrophenyl alpha-L-arabinofuranoside as substrates. The reactions may be carried out in 50 mM citrate buffer at pH 6.0, 40° C. with a total reaction time of 30 min. The reaction is stopped by adding 0.5 ml of 1 M sodium carbonate and the liberated p-nitrophenol is measured at 405 nm. Activity is expressed in U/ml.

### Example 1

### White Pan Bread

Bread was baked with alpha-L-arabinofuranosidase family 51 (GH51—SEQ ID:2).

All breads contained a common background of maltogenic alpha-amylase enzyme to ensure bread had eating quality during storage comparable to those found in commercial breads.

The GH51 was used at a dosage of 20, 40, and 80 mg per kg flour.

The common background of fresh-keeping enzyme was composed of a maltogenic alpha-amylase from Bacillus stearothermophilus (Novamyl Pro 80 BG obtainable from Novozymes NS) at a dosage of 35 and 70 mg per kg flour. The dosage levels of the maltogenic alpha-amylase are industrially relevant to pan bread, and thus an increase in bread quality properties beyond what is achievable by the maltogenic alpha-amylase alone is of technological relevance.

Doughs were prepared according to a standard European straight dough procedure with 40 g yeast, 20 g salt, 20 g sugar, 60 ppm ascorbic acid, and 4 g calcium propionate (as preservative) per kg of flour. The doughs were scaled to 700 g and baked in lidded pans.

To evaluate the properties of the bread crumb properties, a panel of at least three persons was used to assess the qualities of the bread.

A loaf of bread (2 h after baking) was broken into two halves and the crumb of which was compared to that of the reference. Evaluation was performed with bread that had cooled down to room temperature. A 10-point system based on Table 1 below was used to score the quality parameters of interest with the score of the reference being 5. The higher the score, the better the quality of the bread.

TABLE 1
Bread evaluation criteria

| | | | |
|---|---|---|---|
| Crust color | 0/Light | 5/Reference | 10/Dark |

Internal crumb properties

| | | | |
|---|---|---|---|
| Pore uniformity | 0/Less | 5/Reference | 10/More |
| Pore size | 0/Open | 5/Reference | 10/Fine |
| Pore cell wall | 0/Thick | 5/Reference | 10/Thin |
| thickness | | | |
| Pore form | 0/Round/Deep | 5/Reference | 10/Elongated/Shallow |
| Crumb color | 0/Dark/Gray | 5/Reference | 10/Light/Bleached |

The breads were evaluated after 1 day after baking and again after 7 and 14 days storage (wrapped in thick polyethylene plastic bags and stored at 22° C.) using sensory evaluation and instrumental texture evaluation.

### Sensory Evaluation was Conducted in the Following Way:

Trained evaluators examined and scored by touch the bread tenderness (by pressing the bread with the fingers) of the breads. The eating properties of the breads in the mouth were also examined and scored in terms of:

Bread softness (resistance to first bite),
Bread moistness,
Bread chewiness,
Bread melting, and
Bread smoothness,
according to the guidelines set out by Watts B. M., Ylimaki G. L., Jeffery L. E., and Elias L. G. (1989), 1^{st} Edition, Basic Sensory Methods for Food Evaluation. International Development Research Center, Ottawa, Canada.

TABLE 2
Sensory bread crumb evaluation criteria
Touch/tactile properties

| | | | |
|---|---|---|---|
| Bread crumb | 1/Much force | 5/Reference | 9/Much less force |
| tenderness | | | |

Crumb eating properties

| | | | |
|---|---|---|---|
| Bread crumb | 1/Very firm | 5/Reference | 9/Very soft |
| softness | | | |
| Bread crumb | 1/Very dry | 5/Reference | 9/Very moist |
| moistness | | | |
| Bread crumb | 1/Very chewy | 5/Reference | 9/Much easier |
| chewiness/ | | | to chew |
| gumminess | | | |
| Bread crumb | 1/Much Less | 5/Reference | 9/Excellent |
| melting | melting | | melting |
| Bread crumb | 1/Very granular/ | 5/Reference | 9/Very smooth |
| smoothness | rough | | |

| | |
|---|---|
| Overall bread | Average of above scores |
| crumb quality | |

### Techniques for Evaluating Textural Characteristics of Bread Crumb:

### Tactile Properties:

Tenderness: Evaluate how easy it is to push down the sample with your fingers.

### Eating Quality:

Softness: Bite down with your front teeth on the sample and evaluate the force required to cut through the sample.

Moistness: Moistness is evaluated in the mouth, when the sample is in contact with the upper palate and the tongue.

Chewiness: Number of chews (at a constant rate) and/or the amount of energy needed to chew a sample before it is ready for swallowing.

Gumminess: Degree to which the sample tends to form balls/lumps in the mouth and imparts a tooth-packing sensation.

Crumb melting: Evaluate how easily the crumb melts in the mouth during mastication.

Crumbliness: Evaluate how easily the sample comes apart during mastication. Samples with good structural integrity are scored as being cohesive.

Smoothness: Evaluate the degree of abrasiveness or how smooth the samples are when rubbed between the tongue and the palate during mastication and swallowing.

### Results

No changes in dough properties were observed by the addition of GH51 in dough with a background of 35 ppm or 70 ppm Novamyl Pro.

The elasticity of the breads decreased with storage time.

Novamyl Pro reduced this decrease.

The addition of GH51 did not affect cohesiveness beyond what was attainable by Novamyl Pro alone.

GH51 did not negatively affect bread elasticity.

The texture and eating quality of bread deteriorates with storage time, and this deterioration is decreased with the addition of Novamyl Pro, as can be seen in Table 3-5.

The addition of GH51 and Novamyl Pro further decreased the texture and eating quality deterioration of bread on day 7 and day 14.

Bread crumb: The overall eating scores such as eating parameters as bread crumb tenderness, bread crumb softness, bread crumb moistness, bread crumb chewiness/gumminess, bread crumb melting, and bread crumb smoothness, improved by the addition of GH51 to bread.

TABLE 3
Change in sensory attributes with storage time of bread with Novamyl Pro and/or with varying
amounts of GH51 per kg flour.
Sensory evaluation of day 1

| | | | 35 ppm | 35 ppm | 35 ppm | | 70 ppm | 70 ppm | 70 ppm |
|---|---|---|---|---|---|---|---|---|---|
| | | | Novamyl | Novamyl | Novamyl | | Novamyl | Novamyl | Novamyl |
| | | 35 ppm | Pro80 + | Pro80 + | Pro80 + | 70 ppm | Pro80 + | Pro80 + | Pro80 + |
| | | Novamyl | 20 ppm | 40 ppm | 80 ppm | Novamyl | 20 ppm | 40 ppm | 80 ppm |
| | Control | Pro80 | GH51 | GH51 | GH51 | Pro80 | GH51 | GH51 | GH51 |
| Touch/ | | | | | | | | | |
| Tactile | | | | | | | | | |
| Properties: | | | | | | | | | |
| Bread | 5 | 6 | 6 | 6.5 | 6 | 6.5 | 6.5 | 6.5 | 7 |
| crumb | | | | | | | | | |
| tenderness | | | | | | | | | |
| Eating | | | | | | | | | |
| properties: | | | | | | | | | |
| Bread | 5 | 6.5 | 6 | 6.5 | 6 | 6.5 | 7 | 7 | 7 |
| crumb | | | | | | | | | |
| softness | | | | | | | | | |
| Bread | 5 | 6 | 6 | 6.5 | 6 | 6.5 | 7 | 7 | 6.5 |
| crumb | | | | | | | | | |
| moistness | | | | | | | | | |
| Bread | 5 | 6 | 6 | 6.5 | 6.5 | 7 | 7 | 7 | 6.5 |
| crumb | | | | | | | | | |
| chewiness/ | | | | | | | | | |
| gumminess | | | | | | | | | |
| Bread | 5 | 6 | 6 | 6.5 | 6 | 6.5 | 6.5 | 6.5 | 6.5 |
| crumb | | | | | | | | | |
| melting | | | | | | | | | |
| Bread | 5 | 6 | 6.5 | 6.5 | 6 | 7 | 7 | 7 | 7 |
| crumb | | | | | | | | | |
| smoothness | | | | | | | | | |
| Overall | 5 | 6.1 | 6.1 | 6.5 | 6.1 | 6.7 | 6.8 | 6.8 | 6.8 |
| Bread | | | | | | | | | |
| quality | | | | | | | | | |

TABLE 4
Change in sensory attributes with storage time of bread with Novamyl Pro and/or with varying
amounts of GH51 per kg flour.
Sensory evaluation of day 7

| | | | 35 ppm | 35 ppm | 35 ppm | | 70 ppm | 70 ppm | 70 ppm |
|---|---|---|---|---|---|---|---|---|---|
| | | | Novamyl | Novamyl | Novamyl | | Novamyl | Novamyl | Novamyl |
| | | 35 ppm | Pro80 + | Pro80 + | Pro80 + | 70 ppm | Pro80 + | Pro80 + | Pro80 + |
| | | Novamyl | 20 ppm | 40 ppm | 80 ppm | Novamyl | 20 ppm | 40 ppm | 80 ppm |
| | Control | Pro80 | GH51 | GH51 | GH51 | Pro80 | GH51 | GH51 | GH51 |
| Touch/ | | | | | | | | | |
| Tactile | | | | | | | | | |
| Properties: | | | | | | | | | |
| Bread | 5 | 6 | 7 | 7 | 6 | 7 | 7 | 7 | 7 |
| crumb | | | | | | | | | |
| tenderness | | | | | | | | | |
| Eating | | | | | | | | | |
| properties: | | | | | | | | | |
| Bread | 5 | 6 | 6 | 7 | 7 | 7 | 8 | 8 | 8 |
| crumb | | | | | | | | | |
| softness | | | | | | | | | |
| Bread | 5 | 6 | 6 | 7 | 7 | 7 | 7 | 8 | 8 |
| crumb | | | | | | | | | |
| moistness | | | | | | | | | |
| Bread | 5 | 6 | 6 | 7 | 7 | 7 | 7 | 8 | 8 |
| crumb | | | | | | | | | |
| chewiness/ | | | | | | | | | |
| gumminess | | | | | | | | | |
| Bread | 5 | 6 | 6 | 7 | 8 | 6 | 7 | 7 | 8 |
| crumb | | | | | | | | | |
| melting | | | | | | | | | |
| Bread | 5 | 6 | 7 | 7 | 8 | 7 | 7 | 8 | 8 |
| crumb | | | | | | | | | |
| smoothness | | | | | | | | | |
| Overall | 5 | 6.0 | 6.3 | 7.0 | 7.2 | 6.8 | 7.2 | 7.7 | 7.8 |
| Bread | | | | | | | | | |
| quality | | | | | | | | | |

TABLE 5
Change in sensory attributes with storage time of bread with Novamyl Pro and/or with varying
amounts of GH51 per kg flour.
Sensory evaluation of day 14

| | | | 35 ppm | 35 ppm | 35 ppm | | 70 ppm | 70 ppm | 70 ppm |
|---|---|---|---|---|---|---|---|---|---|
| | | | Novamyl | Novamyl | Novamyl | | Novamyl | Novamyl | Novamyl |
| | | 35 ppm | Pro80 + | Pro80 + | Pro80 + | 70 ppm | Pro80 + | Pro80 + | Pro80 + |
| | | Novamyl | 20 ppm | 40 ppm | 80 ppm | Novamyl | 20 ppm | 40 ppm | 80 ppm |
| | Control | Pro80 | GH51 | GH51 | GH51 | Pro80 | GH51 | GH51 | GH51 |
| Touch/ | | | | | | | | | |
| Tactile | | | | | | | | | |
| Properties: | | | | | | | | | |
| Bread | 5 | 6.5 | 7.5 | 7 | 7.5 | 8 | 8 | 8.5 | 9 |
| crumb | | | | | | | | | |
| tenderness | | | | | | | | | |
| Eating | | | | | | | | | |
| properties: | | | | | | | | | |
| Bread | 5 | 6 | 7.5 | 7.5 | 7.5 | 7.5 | 7 | 7.5 | 8 |
| crumb | | | | | | | | | |
| softness | | | | | | | | | |
| Bread | 5 | 6 | 7 | 7.5 | 6.5 | 7.5 | 7 | 8 | 8 |
| crumb | | | | | | | | | |
| moistness | | | | | | | | | |
| Bread | 5 | 6 | 6.5 | 7 | 6.5 | 7 | 7 | 7.5 | 7.5 |
| crumb | | | | | | | | | |
| chewiness/ | | | | | | | | | |
| gumminess | | | | | | | | | |
| Bread | 5 | 6 | 6.5 | 7 | 7 | 6.5 | 7 | 7.5 | 7.5 |
| crumb | | | | | | | | | |
| melting | | | | | | | | | |
| Bread | 5 | 6 | 7 | 7 | 7 | 7 | 7 | 7.5 | 7.5 |
| crumb | | | | | | | | | |
| smoothness | | | | | | | | | |
| Overall | 5 | 6.1 | 7.0 | 7.2 | 7.0 | 7.3 | 7.2 | 7.8 | 7.9 |
| Bread | | | | | | | | | |
| quality | | | | | | | | | |

1. A method for modifying the crumb of a baked product comprising adding an arabinofuranosidase and an anti-staling amylase to dough ingredients and baking the dough to provide the baked product, wherein the anti-staling amylase is a maltogenic alpha-amylase or a glucan 1,4-alpha-maltotetrahydrolase.

2. The method according to claim 1, wherein the baked product is a bread or a cake.

3. The method according to claim 1, wherein the arabinofuranosidase belongs to family 43, family 51, family 54, or family 62.

4. The method according to claim 1, wherein the arabinofuranosidase has an amino acid sequence having at least 70% identity to SEQ ID NO:1 or SEQ ID NO:2.

5. The method according to claim 1, wherein the bread crumb of the bread product has improved bread crumb melting properties compared to a baked product prepared without arabinofuranosidase.

6. The method according to claim 1, wherein the bread crumb of the bread product has improved bread crumb smoothness properties compared to a baked product prepared without arabinofuranosidase.

7. The method according to claim 1, wherein additionally a phospholipase is added to the dough ingredients.

8. The method according to claim 1, wherein additionally one or more enzymes selected from the group consisting of a xylanase, an amylase, a galactolipase, a protease, a transglutaminase, a cellulase, a hemicellulase, an acyltransferase, a protein disulfide isomerase, a pectinase, a pectate lyase, an oxidoreductase, a peroxidase, a laccase, a glucose oxidase, a pyranose oxidase, a hexose oxidase, a lipoxygenase, an L-amino acid oxidase, a carbohydrate oxidase, a sulfurhydryl oxidase, and a glucoamylase is added to the dough ingredients.

9. A baked product obtainable by the method according to claim 1.

10. (canceled)

11. (canceled)

12. (canceled)

13. The method according to claim 1, wherein the baked product is a pan bread.


SEQUENCE LISTING (2 sequences)

SEQ ID NO: 1 - protein, 531 aa, Humicola insolens
QASTFTNPVLWEDHPDLEVFRVGSVFYYSSSTFAYSPGAPVLKSYDLVHWTPVTHSVPRLNFGSNYDLPSGTPGAYVKGIWASTLRYRRSNDRFYWYGCVEGRTYLWTSPGGNALANNGEVPPSAWNWQHTATIDNCYYDAGLLIDDDDTMYIAYGNPTINVAQLSPDGTRQVRVQQRVYAHPQGQTVEGARMYKIRGNYYILVTRPADAEYVLRSTTGSPFGPYEARTLVSRIQGPLANAGFAHQGGIVDAPDGTWHYVAFMDAYPGGRIPVVAPLRWTADGWPEVVTDSQGRWGTSYPIPVRGAKNATEGLASTDLDEFRGTRFSEHWEWNHNPDTSKFTLLGGNEGGLILRTATVTGDLFAARNTLTRRIAGPKASGIFRLDVRGMRDGDRAGAVLFRDRAAYIGVWKQGNEARIVMVDDLRLNEDGWRTASTGRVAANGPVIDTNAQQDIWLRIDADITPAFGTNTERTTTFYYSIDGGRTYTRLGPAFAMTNSWRYFTGYRFGVFNFSTKSLGGEVKVKGFKMNMI

SEQ ID NO: 2 - protein, 627 aa, Meripilus giganteus
VTVTVNKNPSHTVPSTLYGLMFEDINHSGDGGLYAELLQNRAFQQVTPNTAAALAAWHPISNAKLAVIQDPSPVSNALPNSLQFSVPSGSSGRVGFTNEGFWGIKVDSTWTYKASLFFRFPTSSSFSGALTVGLQTNAGRVLAQNSTQIRGTTTKWTQINLELHPTASAPDVSNSFFVTIDGAAGAGQTINFAMFSLFPPTFKNRPNGLRADIAETLAEMGPSFFRFPGGNNLEGQTTATRWQWNATVGSLLDRPGRVGDWGYVNTDGLGLLEYLQFFEDTGMEPIMAVWAGYSLGGTSLAENQLAPYIQQAIDQINFVIGDPAKSAPAALRASLGHPEPFTLRFVEVGNEDFFAAGSYPYRWHDFVTALQAQFPQIRFIATTNAWNPVLSPVPQSYDVHVYQTPTWFYQNAFYYDGFQRNGTTYFEGEYAAISTNANDLFGTVADGRLAFPTVQSATGEAAFMTGLERNSDIVFAASYAPLLQHVNSTQWTPDLVSYDAGSVIKSTSFFAQKLFALNKGDQYLPSTLPTNGGTLHWSITRASSSGKTFIKIANAGSSAQSLTFQLTQFNSVSSTGTLQVLTGPETASNTPEAPQAIVPKTSTIGTGKTFTYNAPAFSVSVITVTTN